(19) United States
(12) Patent Application Publication
(10) Pub. No.: US 2013/0290313 A1
(43) Pub. Date: Oct. 31, 2013

(54) METHOD AND SYSTEM OF USING DOMAIN RANKING FOR CALCULATING A CALL NUMBER FOR REPRESENTATIONS

(71) Applicants: Erik Todd Collier, Livermore, CA (US); Wahid Chrabakh, Fremont, CA (US); Neeraj Bhatnagar, Fremont, CA (US)

(72) Inventors: Erik Todd Collier, Livermore, CA (US); Wahid Chrabakh, Fremont, CA (US); Neeraj Bhatnagar, Fremont, CA (US)

(73) Assignee: IAC SEARCH & MEDIA, INC., Oakland, CA (US)

(21) Appl. No.: 13/459,582

(22) Filed: Apr. 30, 2012

(51) Int. Cl. G06F 17/30; G06F 15/16

(52) U.S. Cl. 707/723; 707/751; 707/E17.014

(57) ABSTRACT

The invention provides a method of distributing representations in a network environment having a host computer system connected over at least one network to a plurality of user computer systems and to a data provider computer system. Domains of representations are ranked in a first historical data set. A query is received from a user computer system within a website. A call number that depends on the rank of the domains of the representations in the first historical data set for the query is calculated, recorded and transmitted from the host computer system over the network to the data provider computer system together with the query. A plurality of representations for the query are received from the data provider computer system over the network at the host computer system and transmitted from the host computer system over the network to the user computer system.

### BACKGROUND OF THE INVENTION

1). Field of the Invention

This invention relates generally to a method and system according to which a host computer system interacts with a data provider computer system and one or more user computer systems, and more specifically to a method and system of using domain ranking for calculating a call number for representations.

2). Discussion of Related Art

A host computer system is often used to receive a query over a network such as the Internet from a user computer system and then to interact over the Internet with a data provider computer system to retrieve representations for the query and then to return the representations in a results page to the user computer system. These representations may for example be advertisements, news articles or the like.

The host computer system usually transmits a call number to the data provider computer system. The data provider computer system then returns a number of representations corresponding to the call number. The host computer system may for example transmit a call number of five, receive five representations from the data provider computer system, and then transmit all five representations to the user computer system.

Not all queries and representations are alike. Some queries may be more commercial than other queries, but if five representations are transmitted for both queries, it may result in an undesirable user experience because too many advertisements are transmitted for a query that is less commercial. Users also prefer to receive advertisements from certain domains than from other domains.

### SUMMARY OF THE INVENTION

The invention provides a method of distributing representations in a network environment having a host computer system connected over at least one network to a plurality of user computer systems and to a data provider computer system, including ranking, with a processor, domains of representations in a first historical data set, receiving, with the processor, a query from a user computer system within a website, calculating, with the processor, a call number, the call number depending on the rank of the representations in the first historical data set for the query, recording, with the processor, the call number for the query, transmitting, with the processor, a call from the host computer system over the network to the data provider computer system corresponding to the query, wherein the call includes the call number for the query, receiving, with the processor, a plurality of representations for the query from the data provider computer system over the network at the host computer system and transmitting, with the processor, the representations from the host computer system over the network to the user computer system.

The invention also provides a host computer system including a processor, a computer-readable medium connected to the processor, a network interface device connected to the processor and connected over at least one network to a plurality of user computer systems and to a data provider computer system and a set of instructions on the computer-readable medium, being executable by the processor. The set of instructions includes a first ranking module ranking domains of representations in a first historical data set, a call calculation module calculating a call number, the call number depending on the rank of the representations in the first historical data set for the query and recording the call number for a query and a website receiving a query from a user computer system, transmitting a call from the host computer system over the network to the data provider computer system corresponding to the query, wherein the call includes the call number for the query, receiving a plurality of representations for the query from the data provider computer system over the network at the host computer system, and transmitting the representations from the host computer system over the network to the user computer system.

The invention further provides a computer-readable medium having stored thereon a set of instructions which, when executed by a processor of a computer carries out method of distributing representations in a network environment having a host computer system connected over at least one network to a plurality of user computer systems and to a data provider computer system, including ranking, with a processor, domains of representations in a first historical data set, receiving, with the processor, a query from a user computer system within a website, calculating, with the processor, a call number, the call number depending on the rank of the representations in the first historical data set for the query, recording, with the processor, the call number for the query, transmitting, with the processor, a call from the host computer system over the network to the data provider computer system corresponding to the query, wherein the call includes the call number for the query, receiving, with the processor, a plurality of representations for the query from the data provider computer system over the network at the host computer system and transmitting, with the processor, the representations from the host computer system over the network to the user computer system.

### BRIEF DESCRIPTION OF THE DRAWINGS

The invention is further described by way of example with reference to the accompanying drawings, wherein:

FIG. 1 is a block diagram of a network environment including a host computer system, a data provider computer system and a plurality of user computer systems, wherein the host computer system includes a website and an application shell;

FIG. 2 is a block diagram similar to FIG. 1 wherein the host computer system further includes a representation detective system and a representation intelligence system that are functionally inserted into the application shell;

FIG. 3 is a screenshot of a browser window that is displayed on a display device at one of the user computer systems, further illustrating a user interface displayed within the browser window;

FIGS. 4, 5 and 6 are tables illustrating performance metrics of the representation detective system;

FIGS. 7, 8 and 9 are tables illustrating performance metrics of the representation intelligence system;

FIG. 10 is a flow chart illustrating a method according to which the host computer system operates;

FIG. 11 is a functional representation illustrating how the representation detective system utilizes block rejection to calculate a call number;

FIG. 12 is a screenshot of a results page of the representation intelligence system without the representation detective system where a more commercial query has been entered;

FIG. 13 is a screenshot of a results page of the representation intelligence system without the representation detective system where a less commercial query has been entered;

FIG. 14 is a table of performance metrics of the representation detective system for one particular query;

FIG. 15 illustrates representations that are returned by the data provider computer system wherein one of the representations has a low performance metric;

FIG. 16 is a time chart illustrating how access control is used to temporarily change the call number in order to determine whether the representation having the low performance metric is still being returned by the data provider computer system;

FIG. 17 illustrates representations that are returned by the data provider computer system wherein one of the representations has a high performance metric; and

FIG. 18 is a block diagram of a machine in the form of a computer system and is used for any one of the computer systems describe herein.

### DETAILED DESCRIPTION OF THE INVENTION

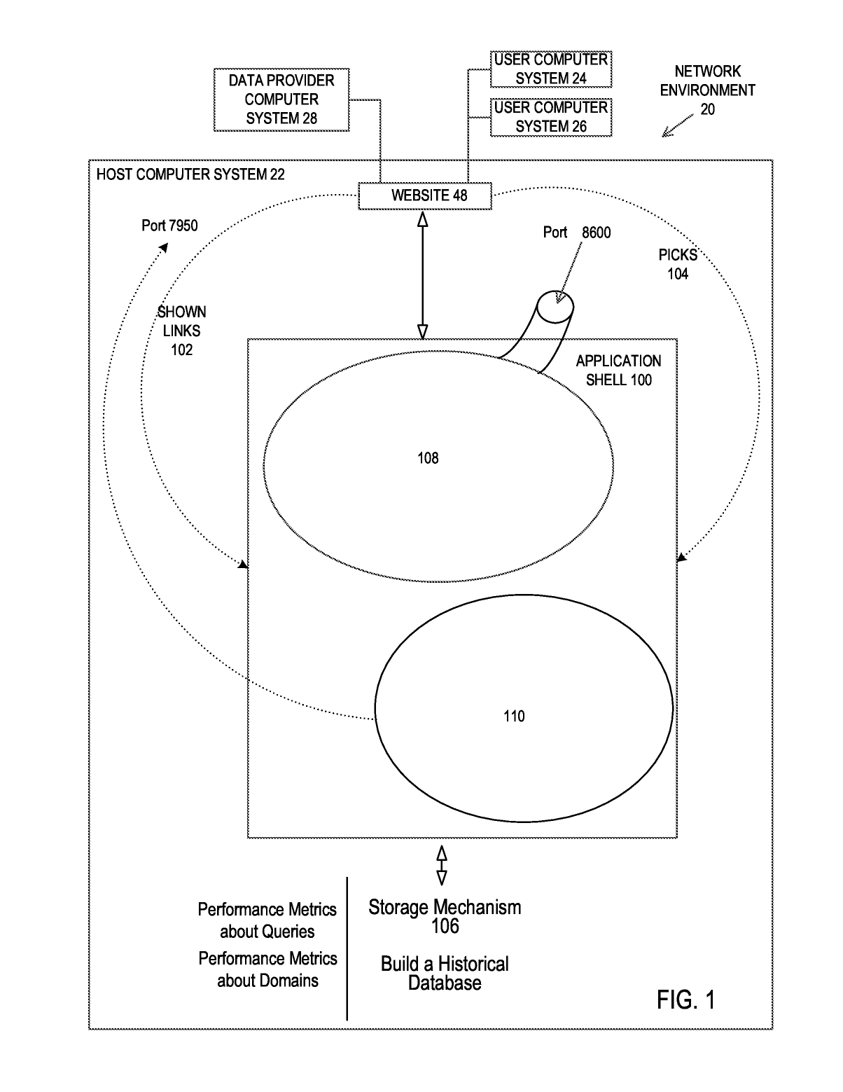

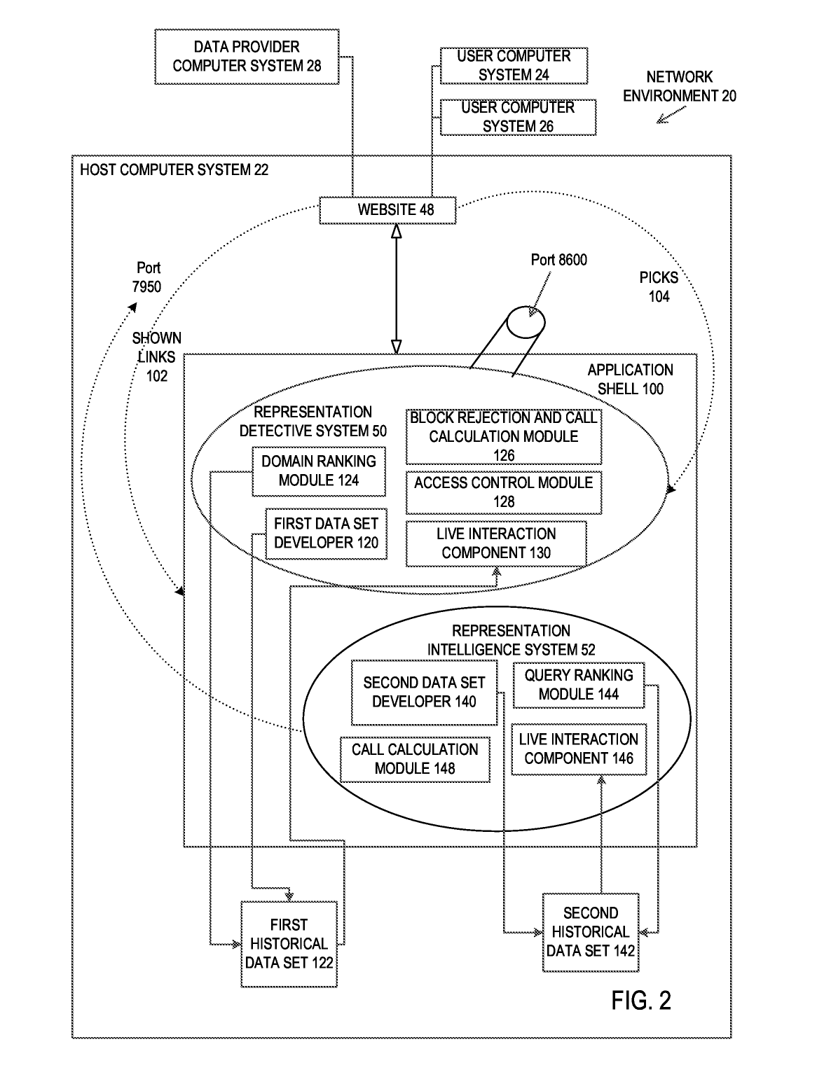

FIGS. 1 and 2 of the accompanying drawings illustrate a network environment 20, according to an embodiment of the invention, having a host computer system 22 connected over at least one network such as the Internet to a plurality of user computer systems 24 and 26 and to a data provider computer system 28.

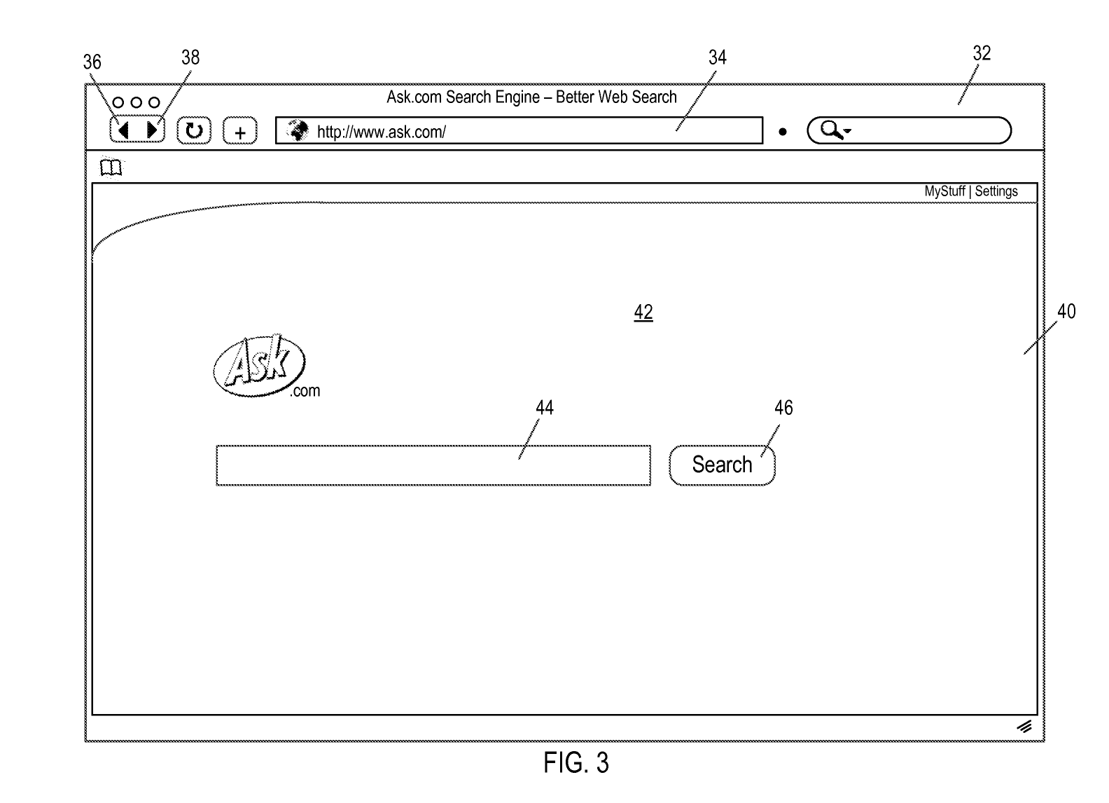

FIG. 3 illustrates a browser window 32 that is displayed on a display device at one of the user computer systems, e.g. the user computer system 24 in FIG. 2. The browser window 32 includes a field 34 for entering a destination address, back and forward buttons 36 and 38, and a viewing pane 40. The user at the user computer system 24 enters an address e.g. <<www.Ask.com>> into the field 34. When the user hits “Enter” on a keyboard, the browser downloads a user interface 42 from the host computer system 22 and displays the user interface 42 within the viewing pane 40. The user interface 42 includes a field 44 for entering a query and a search button 46. The user enters a query within the field 44 and then selects the search button 46 to transmit the query from the user computer system 24 to the host computer system 22.

As shown in FIG. 2, the host computer system 22 includes a website 48. The website 48 receives the request for the user interface 42 from the user computer system 24, transmits the user interface 42 to the user computer system 24, receives the query from the user computer system 24, and then interacts with the data provider computer system 28.

The website 48 transmits a call number to the data provider computer system 28. The website 48 simultaneously transmits the query received from the user computer system 24 to the data provider computer system 28. The data provider computer system 28 then utilizes the query to identify representations matching the query. As will be described herein, the representations are advertisements, although it should be understood that the data provider computer system may also provide other feeds such as news feeds.

Once the representations matching the queries have been identified, the data provider computer system 28 returns the representations to the website 48. The data provider computer system 28 however limits the number of representations transmitted to the website 48 to the call number. For example, if the data provider computer system 28 has identified seven representations, but the call number is five, then the data provider computer system 28 will only transmit five representations to the website 48. In situations where the data provider computer system 28 has identified fewer than five representations, for example three representations, then only the three representations that have been identified are transmitted by the data provider computer system 28 to the website 48.

The website 48 then receives the plurality of representations for the query from the data provider computer system 28 over the network. The website 48 then places the representations within a results page and transmits the results page, with the representations, over the network, to the user computer system 24. When the user computer system 24 receives the results page, the results page is displayed within the viewing pane 40 of FIG. 3 and thus replaces the user interface 42.

If the user selects one of the representations in the results page, the browser is redirected to a URL of the representation. A script in the results page is automatically executed so that a recording signal is simultaneously transmitted from the user computer system 24 over the network 20 to the website 48 and is recorded within one or more data sets at the host computer system 22. As such, all responses for a given query are recorded within the data set. The data set can then be ranked for the respective query.

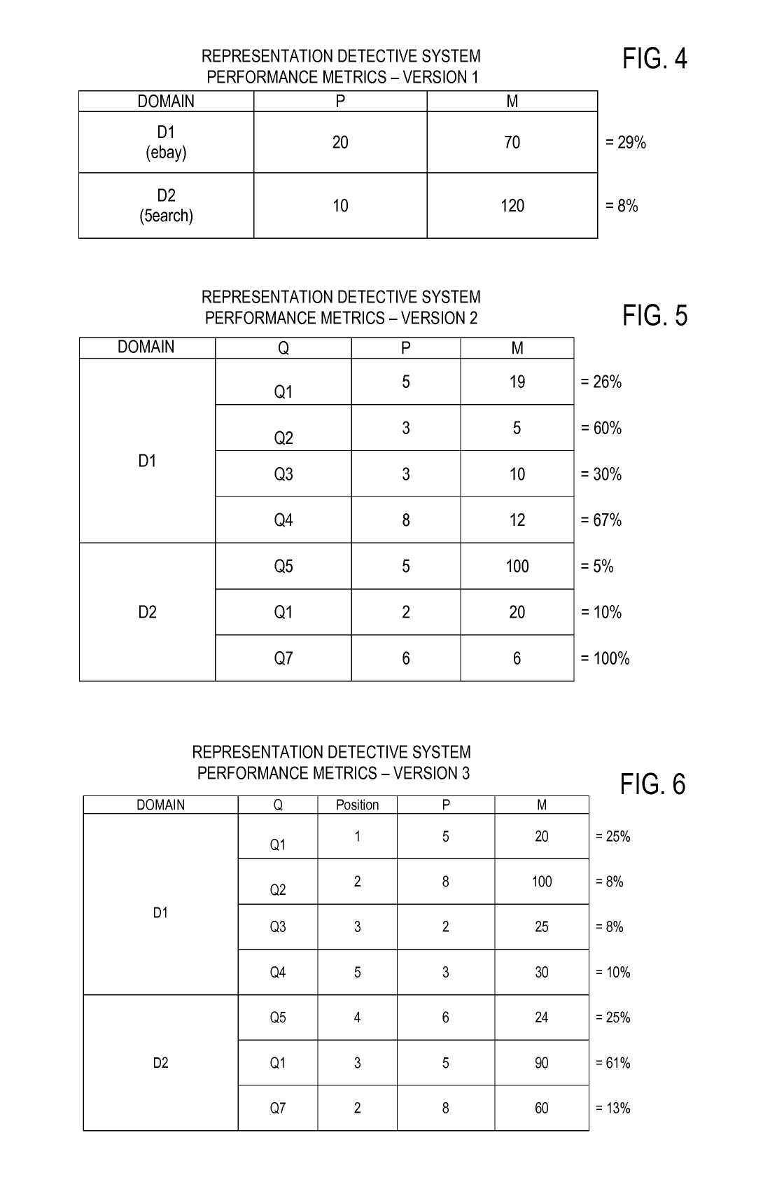

FIG. 4 illustrates one manner according to which the data set can be ranked for a representation detective system. In the example in FIG. 4, the domains of the representations are ranked. For example, if a user selects a URL, <<www.ebay.com/digitalcamera/canon/eos>>, then the domain, namely “eBay” or “ebay.com” is recorded and ranked. In the example in FIG. 4, column M indicates the matches, or the number of representations that have been transmitted to user computer systems 24 and 26 having the domain “eBay” to total 70. Of the 70 representations, users have selected the representations 20 times, or 29% of the time. Users however only select representations with the domain “5earch” 8% of the time. The domain “eBay” has a better performance metric than the domain “5earch.” The performance metric of a particular domain can then be used for determining the call number to be transmitted from the website 48 to the data provider computer system 28. For example, the call number may be calculated to include representations for the domain “eBay” and to exclude representations for the domain “5earch.”

FIG. 5 illustrates another way that the domains can be ranked. In this example, each domain has a sufficient number of data associated therewith to be able to be ranked with respect to a plurality of queries that have been submitted. The ranking of FIG. 5 allows for a finer statistical determination of the performance metrics of the particular domain for the particular query.

FIG. 6 illustrates that the domains can also be ranked based on the position that the domain was presented in. Although not shown, the position can be included in the score for the ranking of a particular domain with additional query granularity.

All four methods shown in FIGS. 4, 5 and 6 can be used simultaneously within a representation detective system. The method of FIG. 4 is typically used if relatively little data is available for a respective query. FIG. 5 would be used if more data is available for the particular query. FIG. 6 is used if even more data is available and is typically used for common queries, e.g. the top 100,000 queries of the last month.

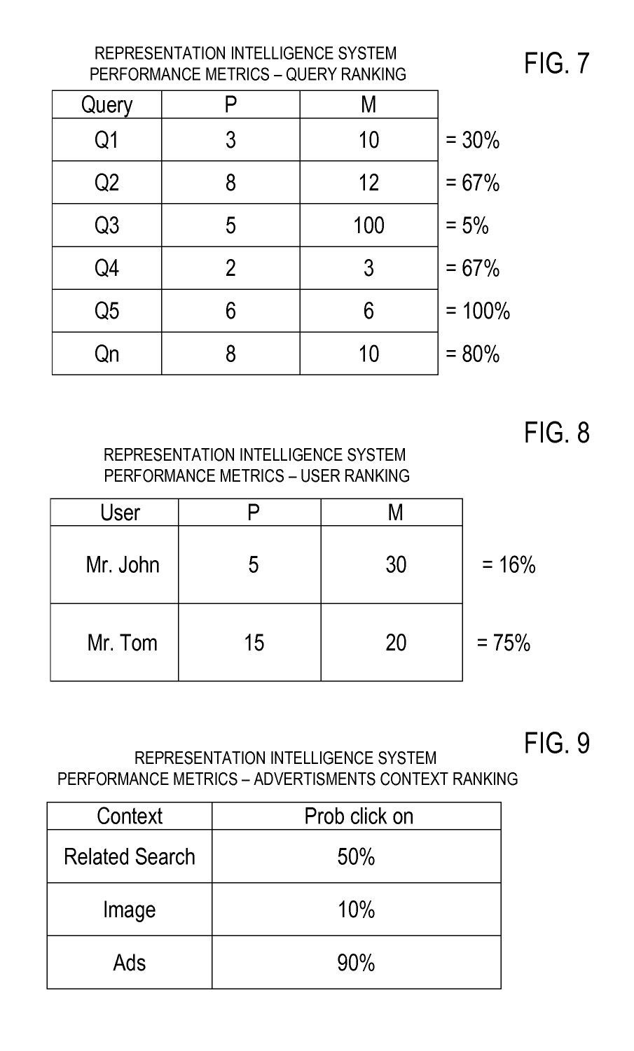

FIG. 7 illustrates how queries are ranked within a representation intelligence system. For query Q1, ten representations have been transmitted to user computer systems 24 and 26, as represented by the column M for “matches.” Of the ten representations, consumers have selected three of the representations as represented by the column P for “picks.” The query Q1 thus has a commerciality of 30%.

FIG. 8 illustrates further metrics that are calculated by the representation intelligence system. Different users are ranked based on the likelihood that they would pick a representation. In the example, Mr. John at 16% is less commercial than Mr. Tom at 75%.

FIG. 9 illustrates a further metric that is determined by the representation intelligence system. If a user is presently searching for related searches, the representation intelligence system is programmed to know that there is a statistical likelihood that the person would select advertisements when presented to the user. In the example, the statistical relationship between related searches and advertisements is 50%. If the consumer is however presently searching for images, there is a lower statistical likelihood that the consumer would be interested in advertisements of 10%. If the consumer is presently searching for advertisements, there is a very high correlation of 90% between the consumer's behavior and the likelihood that the consumer would select an advertisement.

The call number that is calculated by the representation intelligence system depends on all the factors in FIGS. 7, 8 and 9. If the query is more commercial in FIG. 7, then a larger call number would be transmitted to the data provider computer system 28 than if the query is less commercial. If the consumer in FIG. 8 is less commercial, then the call number will also be smaller than if the consumer is more commercial. If the consumer's behavior as shown in FIG. 8 is more relevant for advertisements, then the call number would also be larger than if the consumer's behavior is less relevant for advertisements.

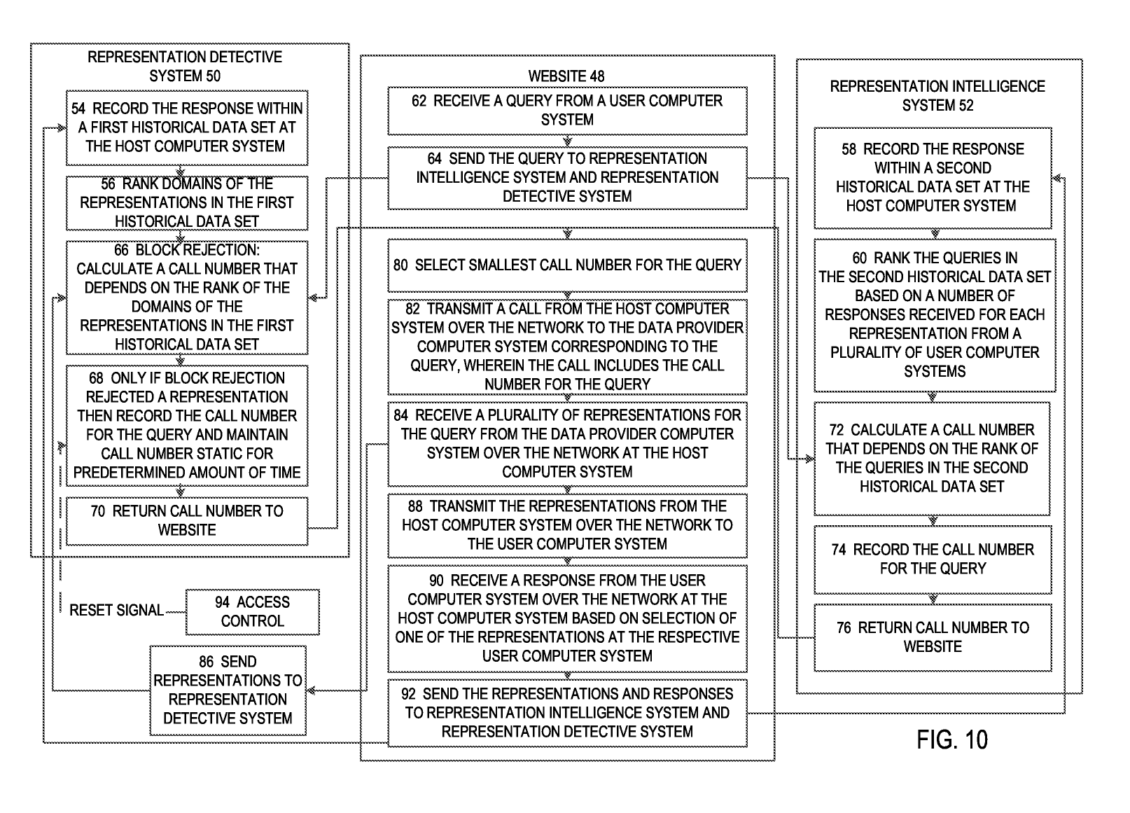

FIG. 10 illustrates a method according to which the host computer system 22 operates. Various steps are illustrated in FIG. 10 and are generally grouped within larger blocks for the website 48, the representation detective system 50 and the representation intelligence system 52.

Within representation detective system 50, at step 54, responses from user computer systems 24 and 26 are recorded within a first historical data set at the host computer system 22. At step 56, the domains of the representations in the first historical data set are ranked as described with reference to FIGS. 4, 5 and 6.

Within the representation intelligence system 52, at step 58, the responses of the user computer systems 24 and 26 are recorded within a second historical data set at the host computer system 22. At step 60, the queries in the second historical data set are ranked based on a number of responses received for each representation from a plurality of user computer systems 24 and 26, as described with reference to FIGS. 7, 8 and 9.

What should be noted at this point is that the ranking of the domains in step 56 and the queries in step 60 occurs over a long period of time, typically over at least one month. The host computer system 22 can thus build up a large amount of data and create rankings that are statistically relevant and significant. In the following description, the response of the host computer system 22 can change very quickly, e.g. every 20 minutes or within minutes or seconds. These responses of the host computer system 22 are not due to sudden changes in the rankings as discussed with reference to FIGS. 4, 5 and 6, but rather because the rankings provide a reference against which the performance the host computer system 22 is tested at any particular time.

At step 62, the website 48 receives a query from a user computer system, e.g. the user computer system 24. At step 64, the website 48 sends the query to the representation intelligence system 52 and the representation detective system 50.

The representation detective system 50, after receiving the query from the website 48 at step 64, then at step 66, executes a block rejection operation wherein the representation detective system 50 calculates a call number that depends on the rank of the domains of the representations in the first historical data set. Other methods of calculating a call number based on the rank of the domains may be used, but block rejections is the preferred method of doing so.

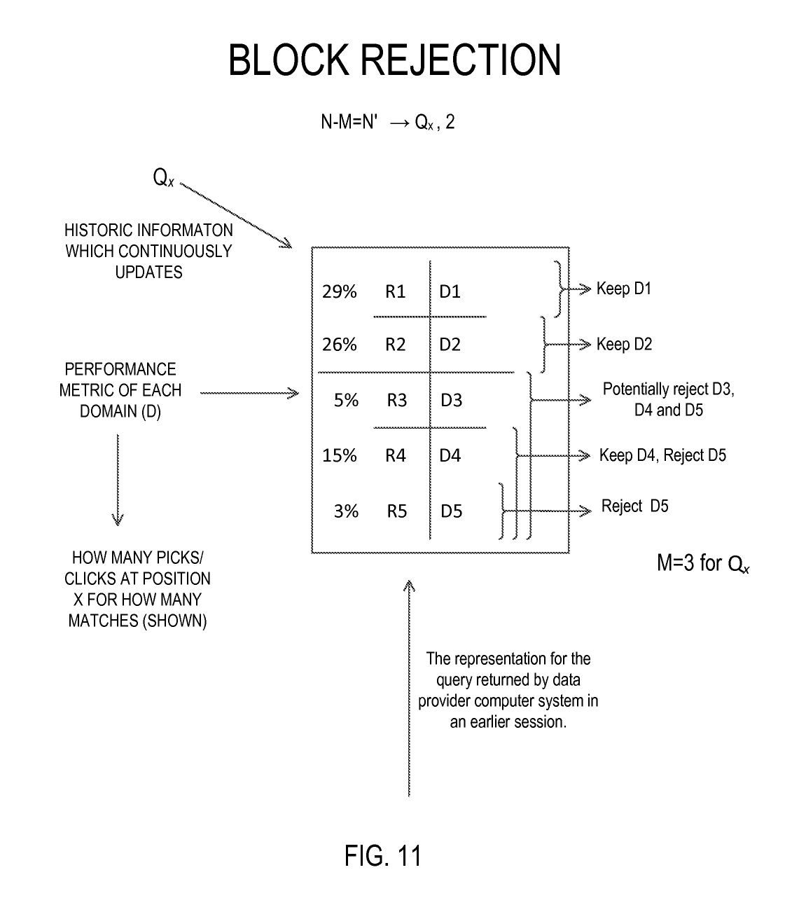

FIG. 11 illustrates the block rejection function in more detail. For a particular query Qₓ, the representations returned by the data provider system 28 are recorded within the representation detective system 50. In the present example, these representations are shown as R1 to R5. The domains of each of the representations R1 to R5 is extracted and are shown as D1 to D5 respectively. A ranking of the domains is also shown. Performance due to a prior session can now be calculated based on the ranking of the domains of the representations that have been returned by the data provider computer system 28. The historic information shown in FIG. 11 is however not static, but updates continuously with subsequent sessions. Because the performance is for a particular query, the query is indicated as Qₓ.

When determining a block to be rejected, a block is selected that includes the last representation and including a series of the representations as provided by the data provider computer system 28 sequentially in reverse order. For now the final representation is the fifth representation R5. First, we assume that the series only includes a single representation, namely the last representation R5. If the threshold performance of the block including only the final representation is, for example 8%, then the final representation R5 is rejected because the domain D5 has performance ranking of 3% which is less than 8%.

Next, the size of the block is increased by 1. The block still includes the last of the representations and includes a series of representations provided by the data provider computer system 28 sequentially in reverse order, but now includes the second to last representation R4. The domain D4 of the representation R4 has been ranked at a 15% performance. A combined ranking of the domains D5 and D4 is then calculated. Such a combined ranking may for example be a total ranking of the domains D5 and D4, in the present example 18%. If we assume that the predetermined threshold for the combined ranking of the domains D5 and D4 is 16%, then the block including the representations D5 and D4 is not rejected because the combined performance of 18% is more than the threshold performance of 16%. It can be seen that the predetermined threshold of 16% for the block including the representations R5 and R4 is larger than the predetermined threshold of 8% of the block that only includes the final representation R5.

Next, the number of representations in the block is again increased by 1, so that the block now includes representations R5, R4 and R3. The representation R3 has a domain D3 with performance ranking of 5%. The total performance of the domains D5, D4 and D3 is thus 23%. Next, we assume that the predetermined threshold of the combined ranking of the domains D5, D4 and D3 is at for example 25%, which is higher than the actual performance of the domains D5, D4 and D3 of 23%. Because the combined performance of the domains D5, D4 and D3 does not meet the predetermined threshold, the entire block is rejected. The entire block is thus rejected regardless of the superior performance of the domain D4. The size of the block is shown as M=3 for Qₓ. On the other hand if the performance ranking of D3 were 3% (bad) but that of D4 and D5 were 25% and 3% respectively (good and bad), the system may have included one bad domain D3 in order to include the good domain D4 but have excluded D5 any ways because it is bad and below D4.

The call number N′ is calculated to be N−M=5−3=2 for query Qₓ. The call number is thus calculated by subtracting a number of representations that are included in the block of the representations to be rejected from the total of representations received from the data provider computer system 28 in a previous session. Only the representations R2 and R1 are retained for a future session because of the superior performance of the domains D2 and D1. The call number for the representation detective system 50 is thus calculated to be two. At step 68 in FIG. 10, the call number calculated by block rejection in step 66 is recorded within the representation detective system 50. Only if block rejection rejected a representation is the call number recorded. No call number is recorded or updated if block rejection did not reject a representation. The call number is then maintained static for a predetermined amount of time, e.g. 20 minutes. At step 70, the representation detective system 50 returns the call number to the website 48 as a call number that can potentially be transmitted from the website 48 to the data provider computer system 28.

As mentioned, the final representation was the fifth representation R5. Block rejection can then be employed to reduce the call number to for example four. In a next session the fourth representation will be the final representation, which will then form the basis of another block rejection calculation.

When the representation intelligence system 52 receives the query from the website 48 following step 64, the representation intelligence system 52 at step 72 calculates a call number that depends on the rank of the queries in the second historical data set. The call number calculated by the representation intelligence system 52 is thus based on the ranking of the queries as described with reference to FIG. 7. The representation intelligence system 52 also factors into the calculation of the call number the user and context metrics described with reference to FIGS. 8 and 9. At step 74, the representation intelligence system 52 records the call number calculated at step 72. At step 76, the representation intelligence system 52 returns the call number recorded at step 74 to the website 48.

At step 80, the website 48 selects the smallest call number for the query. The representation intelligence system 52, for example at step 76, returns a call number of four and the representation detective system 50, at step 70, may return a call number of two, in which case the website 48 selects a call number of two. If the representation detective system 50 at step 70 returns a call number of more than four then the website 48 at step 80 selects a call number of four.

At step 82, the website 48 transmits a call from the host computer system 22 over the network 20 to the data provider computer system 28. The call includes the query and includes the call number for the query that has been selected at step 80. The data provider computer system 28 then extracts a number of representations from a data store and transmits the representations to the website 48 in response to the call. The number of representations transmitted by the data provider computer system 28 is no more than the call number that has been transmitted in the call at step 82. At step 84, the website 48 on behalf of the host computer system 22 receives the plurality of representations for the query from the data provider computer system 28 over the network 20. These representations are not permitted to be reordered, per an agreement between operators of the host computer system 22 and the data provider computer system 28.

At step 86, the representations received at step 84 are transmitted to the representation detective system 50. As mentioned with reference to FIG. 11, the five representations are from a previous session. The representations that are received are sent to the representation detective system 50 at step 86 and then form such a previous session when a subsequent query is received from a user computer system in a subsequent session.

At step 88, the website 48 transmits the representations in a results page from the host computer system 22 over the network 20 to the user computer system 24. The representations are still in the same order as when they were received from the data provider computer system 28. The user at the user computer system 24 may or may not select one or more of the representations. If a representation is selected, a response is transmitted from the user computer system 24 back to the website 48. At step 90, the website 48 receives the response from the user computer system 24 over the network 20 on behalf and at the host computer system 22 based on the selection of the representation at the respective user computer system 24. At step 92, the website 48 sends the representations and the responses to the representation intelligence system 52 and the representation detective system 50. The representation detective system 50 then again records the response at step 54 and the representation intelligence system 52 records the response at step 58.

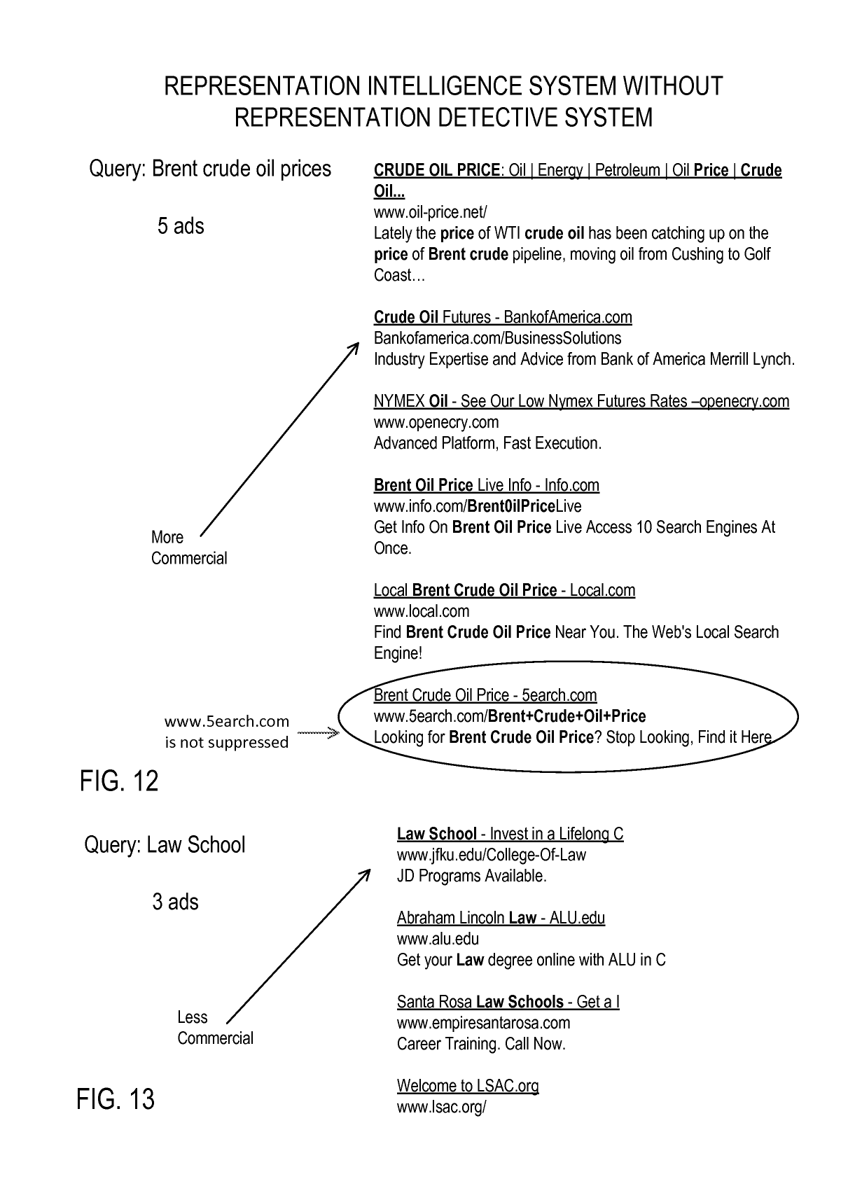

FIG. 12 illustrates the representations that will be received based on the representation intelligence system 52 alone and without involvement of the representation detective system 50. The representation intelligence system 52 has calculated that the call number is six because the query “Brent Crude Oil Prices” has been determined as discussed with reference to FIG. 7 to have relatively high commerciality. The representation intelligence system 52 however does not rank the domains and does not suppress the final result from the final domain “5earch.” As a comparison, FIG. 13 shows a query “Law School” that is less commercial and the representation intelligence system 52 has returned a call number of four because the query is less commercial than the query for FIG. 12. The representation intelligence system 52 however has no way of suppressing the final representation in FIG. 12. Because the representation detective system 50 now ranks the domains, it overrides the representation intelligence system 52 and may return a call number of less than six, for example five to suppress the representation with the domain “5earch.”

Block rejection suppresses representations based on relatively recent feedback from the data provider computer system 28 received at step 84 in FIG. 10 as compared with long term ranking of domains at step 56 in FIG. 10. As described with reference to FIG. 11, the historic information received at step 84 continually updates. It may thus be possible that block rejection carried out at step 66 in FIG. 10 will generate a call number that initially suppresses a domain with a low ranking within the performance metrics of the representation detective system 50 as described with reference to FIGS. 4, 5 and 6, but that the domain with the low performance ranking then falls away within the data provider computer system 28. Block rejection may then unnecessarily suppresses a domain with a relatively good ranking within the performance metrics of FIGS. 4, 5 and 6 that replaces the domain with the low ranking.

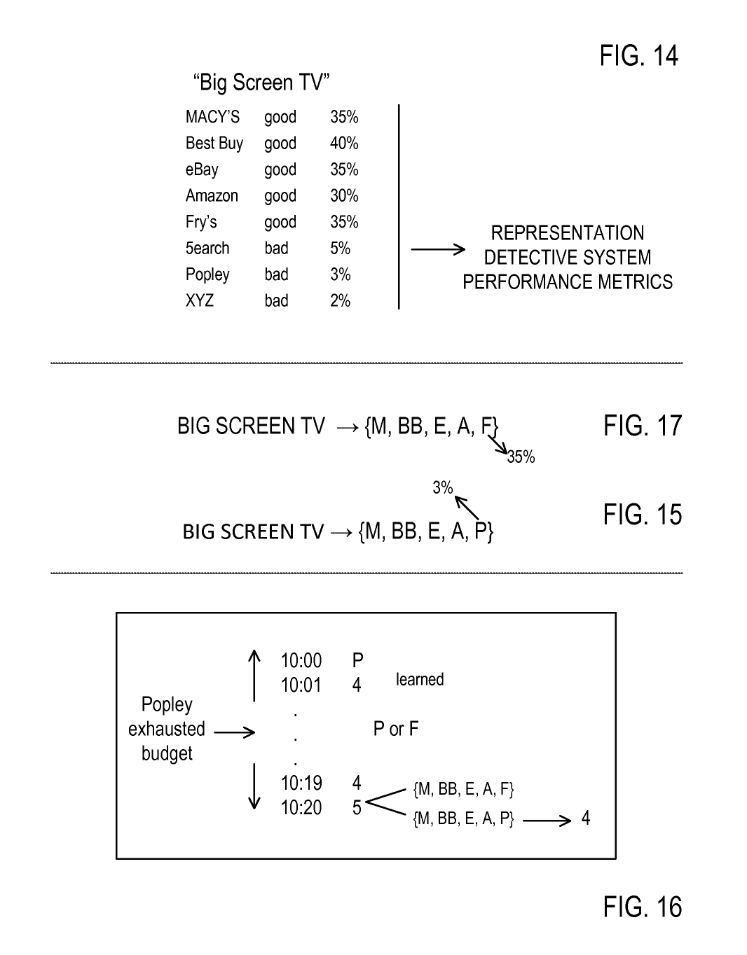

FIG. 14 shows a number of domains and their ranking within the performance metrics of FIGS. 4, 5 and 6 of the representation detective system 50. According to long historic data generated for the domains, it has been determined that the domain for “Fry's” has a high ranking and is for purposes of further discussion regarded as good. The domain for “Popley” has a low ranking and is regarded as bad. Referring to FIG. 15, a query for “Big Screen TV” initially returns representations for “Macy's” (M), “Best Buy” (BB), “eBay” (E), “Amazon” (A) and “Popley” (P). The first four representations are good and the final representation is considered to be bad.

As shown in FIG. 16, at 10:00 AM, the five representations in FIG. 15 are received, including the representation for “Popley.” At 10:01 AM, the representation detective system 50 has calculated and recorded a call number of four. Should the query for “Big Screen TV” again be received, the representation for “Popley” will be suppressed. Between 10:01 AM and 10:19 AM, it is possible that “Popley” has exhausted its budget with the data provider computer system 28. As shown in FIG. 17, should five representations be called by the website 48 from the data provider computer system 28, that the representation for “Popley” would be replaced with a representation for “Fry's” (F) which is considered to be good. However, because the call number is maintained static, the call number remains at four. The host computer system 22 will thus lose potential revenue for “Fry's” because “Fry's” would now be suppressed.

As further illustrated in FIG. 10, an access control step 94 periodically creates a reset signal for the call number within the representation detective system 50. Referring again to FIG. 16, at 10:20 AM the access control step 94 in FIG. 10 resets the call number from four to five (or higher). Five representations are then retrieved from the data provider computer system 28 by the website 48. One of two things may then occur. First, if the representation for “Popley” has been replaced by the representation for “Fry's,” the call number will be maintained at five. The call number is maintained at five because of the way that the call number is calculated using the block rejection step described with reference to step 66 in FIG. 10 with the additional assistance of FIG. 11. Second, it is possible that “Popley” is still included as the final representation. The block rejection step 66 in FIG. 10 will then calculate a call number of four, thus again suppressing “Popley”.

The access control step 94 in FIG. 10 resets the call number from a first number (in the present example four) to a second number (in the present example five) that is higher than the first number, whereafter a determination is again made to maintain the call number at the second number or reduce the call number to a third number (in the present example also four) that is less than the second number based on the ranking of the domains of the representations within the representation detective system 50. The access control step 94 has a clock detection function that repeatedly resets the call number after a fixed period of time as determined by the clock detection function. In the present example, the call number is reset to five after 20 minutes and again periodically to five every 20 minutes.

Referring again to FIG. 1, the host computer system 22 includes an application shell 100 connected to the website 48. The application shell 100 listens for shown links 102, i.e. matches or representation, that have been transmitted to user computer systems 24 or 26 and picks 104, i.e. selections made by users at the user computer systems 24 and 26. The application shell 100 also has a storage mechanism 106 with the ability to build a historical database and generate performance metrics about queries.

A feature of the application shell 100 is that it provides an integration functionality 108 and 110 for other applications to be integrated therewith. The integration functionality 108 is accessible through a port, illustrated as Port 8600. Similarly, the integration functionality 110 is accessible through a port, illustrated as Port 7950. In general, the application shell 100 is responsible for executing the methods of receiving the plurality of representations for the query from the data provider computer system over the network at the host computer system and receiving the response from the user computer system over the network at the host computer system based on selection of one of the representations at the respective user computer system.

FIG. 2 illustrates two applications, namely the representation detective system 50 and the representation intelligence system 52, that have been inserted into the application shell 100 and integrate functionally with the integration functionality 108 and 110 respectively. The representation detective system 50 is a first representation system that executes the method of receiving the query from the website 48, ranking the representations in a first historical data set 122, calculating the call number in the first historical data set 122 for the query, recording the call number for the query and recording the response within the first historical data set 122.

The representation intelligence system 52 is second representation system that executes the method of receiving the query from the website 48, ranking the representations in the second historical data set 142, calculating the call number, recording the call number for the query and recording the response within the second historical data set 142.

The representation detective system 50 includes a first data set developer 120, the first historical data set 122, a domain ranking module 124, a block rejection and call calculation module 126, the access control module 128 and a live interaction component 130. The first data set developer 120 develops the first historical data set 122 with the assistance of the application shell 100. The domain ranking module 124 ranks the domains within the first historical data set 122 with the assistance the application shell 100. The live interaction component 130 receives a query from the website 48 and returns a call number to the website 48. The block rejection and call calculation module 126 calculates a call number based on the ranking of the domains within the first historical data set 122. The access control module 128 executes the access control step 94 in FIG. 10.

The representation intelligence system 52 includes a second data set developer 140, a second historical data base 142, a query ranking module 144, a live interaction component 146 and a call calculation module 148. The second data set developer 140 develops the second historical data set 142 with the assistance of the application shell 100. The query ranking module 144 ranks the queries within the second historical data set 142. The live interaction component 146 receives a query from the website 48 and returns a call number to the website 48 after the call number is calculated by the call calculation module 148.

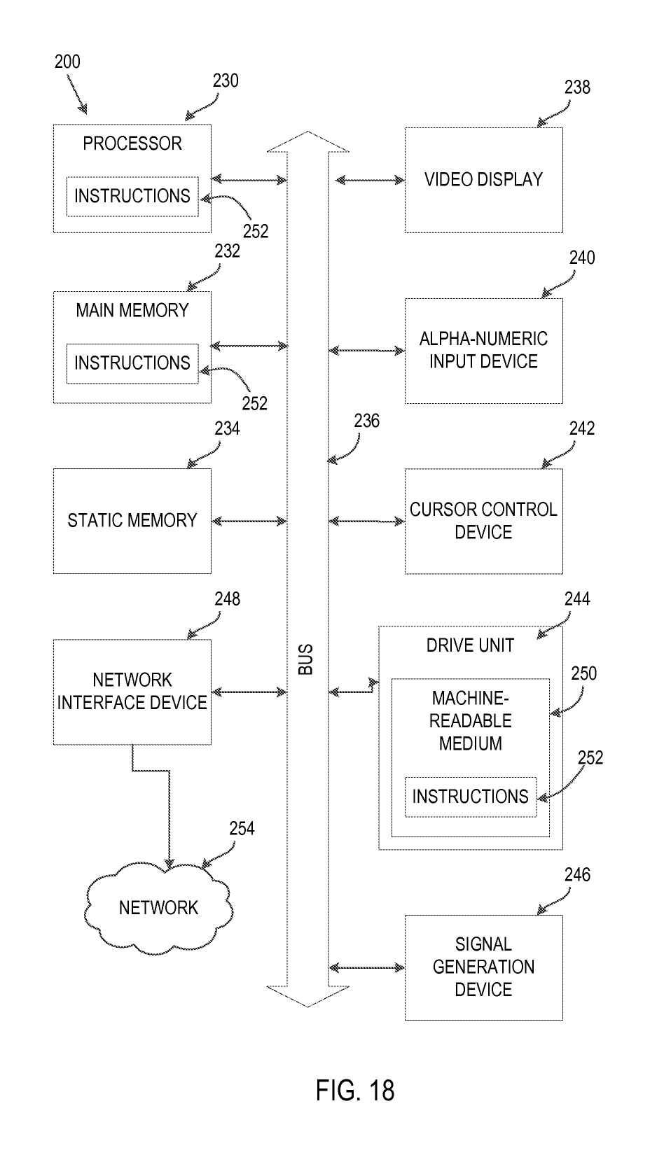

FIG. 18 shows a diagrammatic representation of a machine in the exemplary form of a computer system 200 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 200 includes a processor 230 (e.g., a central processing unit (CPU), a graphics processing unit (GPU), or both), a main memory 232 (e.g., read-only memory (ROM), flash memory, dynamic random access memory (DRAM) such as synchronous DRAM (SDRAM) or Rambus DRAM (RDRAM), etc.), and a static memory 234 (e.g., flash memory, static random access memory (SRAM, etc.), which communicate with each other via a bus 236.

The computer system 200 may further include a video display 238 (e.g., a liquid crystal display (LCD) or a cathode ray tube (CRT)). The computer system 200 also includes an alpha-numeric input device 240 (e.g., a keyboard), a cursor control device 242 (e.g., a mouse), a disk drive unit 244, a signal generation device 246 (e.g., a speaker), and a network interface device 248.

The disk drive unit 244 includes a machine-readable medium 250 on which is stored one or more sets of instructions 252 (e.g., software) embodying any one or more of the methodologies or functions described herein. The software may also reside, completely or at least partially, within the main memory 232 and/or within the processor 230 during execution thereof by the computer system 200, the memory 232 and the processor 230 also constituting machine readable media. The software may further be transmitted or received over a network 254 via the network interface device 248.

While the instructions 252 are shown in an exemplary embodiment to be on a single medium, the term “machine-readable medium” should be taken to understand a single medium or multiple media (e.g., a centralized or distributed database or data source and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of distributing representations in a network environment having a host computer system connected over at least one network to a plurality of user computer systems and to a data provider computer system, comprising:
ranking, with a processor, domains of representations in a first historical data set;
receiving, with the processor, a query from a user computer system within a website;
calculating, with the processor, a call number, the call number depending on the rank of the representations in the first historical data set for the query;
recording, with the processor, the call number for the query;
transmitting, with the processor, a call from the host computer system over the network to the data provider computer system corresponding to the query, wherein the call includes the call number for the query;
receiving, with the processor, a plurality of representations for the query from the data provider computer system over the network at the host computer system; and
transmitting, with the processor, the representations from the host computer system over the network to the user computer system.

2. The method of claim 1, wherein domains of the representations in the first historical data set are ranked based on a comparison of picks (user responses to the host computer system) to matches (representations transmitted from the host computer system to the user computer systems) at the host computer system as opposed to the data provider computer system.

3. The method of claim 2, wherein domains of the representations in the first historical data set are ranked in part based on different queries associated with each domain.

4. The method of claim 3, wherein domains of the representations in the first historical data set are ranked based on presentation position (a position among representations transmitted to the user computer systems).

5. The method of claim 1, wherein reordering of the representations received from the data provider computer system is not permitted before transmission of the representations to the user computer system.

6. The method of claim 1, further comprising:
receiving, with the processor, a response from the user computer system over the network at the host computer system based on selection of one of the representations at the respective user computer system; and
recording, with the processor, the response within the first historical data set at the host computer system.

7. The method of claim 1, further comprising:
sending, with the processor, the query from the website to a representation detective system for calculating and recording the call number in the representation detective system; and
returning, with the processor, the call number from the representation detective system to the website for transmission to the data provider computer system.

8. The method of claim 6, further comprising:
ranking, with the processor, in a representation intelligence system, queries in a second historical data set based on a number of responses received for each representation from a plurality of user computer systems;
calculating, with the processor, a call number in the representation intelligence system that depends on the rank of the queries in the second historical data set;
recording, with the processor, the call number for the query in the representation intelligence system;
sending, with the processor, the query from the website to the representation intelligence system;
returning, with the processor, a call number from the representation intelligence system to the website; and
selecting, with the processor, a call number for transmission to the data provider computer system, the call number that is selected being the smallest call number returned from the representation detective system and representation intelligence system.

9. The method of claim 8, further comprising:
receiving, with the processor, a response from the user computer system over the network at the website of the host computer system based on selection of one of the representations at the respective user computer system;
sending, with the processor, the response from the website to the representation detective system and the representation intelligence system; and
recording, with the processor, the response within the first and second historical data sets at the host computer system.

10. The method of claim 1, further comprising:
determining, with the processor, a ranking of the representations received from the data provider computer system;
determining, with the processor, a block of the representations to be rejected, the block including a last of the representations and including a series of the representations as provided by the data provider computer system sequentially in reverse order, wherein a combined ranking of the block is determined to be below a predetermined threshold, wherein the call number is calculated by subtracting a number of the representations that are included in the block of the representations to be rejected from a total number of representations received from the data provider computer system.

11. The method of claim 1, further comprising:
executing, with the processor, an access control module to periodically reset the call number by recording a call number that is higher than the call number that is calculated based on the ranking of the representations for the query, wherein if a plurality of identical queries are received, the call number remains at a first number for a predetermined period of time, whereafter the call number is reset to a second number that is higher than the first number by the access control module, whereafter a determination is made to maintain the call number at the second number or to reduce the call number to a third number that is less than the second number based on the ranking of the representations for the query.

12. The method of claim 1, wherein an application shell executes the method of:
receiving, with the processor, the plurality of representations for the query from the data provider computer system over the network at the host computer system;
receiving, with the processor, the response from the user computer system over the network at the host computer system based on selection of one of the representations at the respective user computer system; and
wherein a first representation system inserted into the application shell executes the method of:
ranking, with the processor, the representations in a first historical data set;
calculating, with the processor, the call number, the call number depending on the rank of the representations in the first historical data set for the query;
recording, with the processor, the call number for the query; and
recording, with the processor, the response within the first historical data set at the host computer system.

13. The method of claim 12, wherein a second representation system inserted into the application shell executes the method of:
ranking, with the processor, the representations in the second historical data set;
calculating, with the processor, the call number, the call number depending on the rank of the representations in the second historical data set for the query;
recording, with the processor, the call number for the query; and
recording, with the processor, the response within the second historical data set at the host computer system.

14. A host computer system comprising:
a processor;
a computer-readable medium connected to the processor;
a network interface device connected to the processor and connected over at least one network to a plurality of user computer systems and to a data provider computer system; and
a set of instructions on the computer-readable medium, being executable by the processor and including:
a first ranking module ranking domains of representations in a first historical data set;
a call calculation module calculating a call number, the call number depending on the rank of the representations in the first historical data set for the query and recording the call number for a query; and
a website receiving a query from a user computer system, transmitting a call from the host computer system over the network to the data provider computer system corresponding to the query, wherein the call includes the call number for the query, receiving a plurality of representations for the query from the data provider computer system over the network at the host computer system, and transmitting the representations from the host computer system over the network to the user computer system.

15. The host computer system of claim 14, further comprising:
a representation detective system, wherein the website sends the query from the website to the representation detective system for calculating and recording the call number in the representation detective system, the representation detective system further comprising:
a live interaction component returning the call number from the representation detective system to the website for transmission to the data provider computer system;
a representation intelligence system including:
a query ranking component ranking, in the representation intelligence system, queries in a second historical data set based on a number of responses received for each representation from a plurality of user computer systems, the website sending the query from the website to the representation intelligence system, the representation intelligence system further including:
a live interaction component returning a call number from the representation intelligence system to the website, the website selecting a call number for transmission to the data provider computer system, the call number that is selected being the smallest call number returned from the representation detective system and representation intelligence system.

16. The host computer system of claim 14, wherein the first ranking module determines a ranking of the representations received from the data provider computer system, further comprising:
a block rejection module determining a block of the representations to be rejected, the block including a last of the representations and including a series of the representations as provided by the data provider computer system sequentially in reverse order, wherein a combined ranking of the block is determined to be below a predetermined threshold, wherein the call number is calculated by subtracting a number of the representations that are included in the block of the representations to be rejected from a total number of representations received from the data provider computer system.

17. The host computer system of claim 14, further comprising:
an access control module that periodically resets the call number by recording a call number that is higher than the call number that is calculated based on the ranking of the representations for the query, wherein if a plurality of identical queries are received, the call number remains at a first number for a predetermined period of time, whereafter the call number is reset to a second or original number that is higher than the first number by the access control, whereafter a determination is made to maintain the call number at the second number or to reduce the call number to a third number that is less than the second number based on the ranking of the representations for the query.

18. A computer-readable medium having stored thereon a set of instructions which, when executed by a processor of a computer carries out method of distributing representations in a network environment having a host computer system connected over at least one network to a plurality of user computer systems and to a data provider computer system, comprising:
ranking, with a processor, domains of representations in a first historical data set;
receiving, with the processor, a query from a user computer system within a website;
calculating, with the processor, a call number, the call number depending on the rank of the representations in the first historical data set for the query;
recording, with the processor, the call number for the query;
transmitting, with the processor, a call from the host computer system over the network to the data provider computer system corresponding to the query, wherein the call includes the call number for the query;
receiving, with the processor, a plurality of representations for the query from the data provider computer system over the network at the host computer system; and
transmitting, with the processor, the representations from the host computer system over the network to the user computer system.
